(19) United States
(12) Patent Application Publication
(10) Pub. No.: US 2008/0059943 A1
(43) Pub. Date: Mar. 6, 2008

(54) METHOD AND SYSTEM FOR USING A LIBRARY CACHE IN A DISTRIBUTED DEVELOPMENT ENVIRONMENT

(76) Inventors: Vadym Krevs, St. Albans (GB); Peter Raymond, St. Albans (GB); Mir Derakhshan, Bengeo (GB)

Correspondence Address: HICKMAN PALERMO TRUONG & BECKER, LLP, 2055 GATEWAY PLACE, SUITE 550, SAN JOSE, CA, 95110, US

(21) Appl. No.: 11/848,145

(22) Filed: Aug. 30, 2007

Related U.S. Application Data
(60) Provisional application No. 60/841,477, filed on Aug. 30, 2006.

(51) Int. Cl. G06F 9/44

(52) U.S. Cl. 717/103

(57) ABSTRACT

Techniques are provided for using library caches in a distributed software development environment that includes a plurality of development sites. Each of the plurality of development sites is associated with at least one library cache area that is accessible over a LAN to a set of network nodes included in that development site. A configuration management server is operable to cause all of a plurality of files associated with a software project to be transferred, in an optimized package, from a file server to a particular development site that is communicatively connected to the file server over a WAN. The configuration management server is also operable to cause the plurality of files to be stored in a particular library cache area that is associated with the particular development site, and to cause one or more of the plurality of files to be transferred from the particular library cache area to a work area that is configured on a developer network node in the particular development site.

### PRIORITY CLAIM

This application claims priority under 35 U.S.C. § 119(e) to U.S. Provisional Patent Application Ser. No. 60/841,477, entitled “METHOD AND SYSTEM FOR USING A LIBRARY CACHE IN A DISTRIBUTED DEVELOPMENT ENVIRONMENT”, filed by Vadym Irevs et al. on Aug. 30, 2006, the entire content of which is hereby incorporated by reference for all purposes as if fully set forth herein.

### FIELD OF THE INVENTION

This invention relates generally to collaborative software development.

### BACKGROUND

The approaches described in this section are approaches that could be pursued, but not necessarily approaches that have been previously conceived or pursued. Therefore, unless otherwise indicated, the approaches described in this section may not be prior art to the claims in this application and are not admitted to be prior art by inclusion in this section.

A distributed software development environment may include multiple, geographically dispersed locations that are configured to participate in collaborative development of software projects. For example, a geographically dispersed software company with multiple office locations may deploy a Local Area Network (LAN) at each office location, where the LANs at the office locations are connected over a Wide Area Network (WAN). The software company may comprise a main office and one or more branch offices, where a local LAN is deployed for each of the main and branch offices and a WAN is used to connect the LANs at the branch offices with the LAN at the main office. This distributed development environment enables developers at any branch office to develop software projects collaboratively with developers at the main office and at any of the other branch offices.

In order to participate in collaborative development of software projects, developers in remote development locations need to have access to project libraries and other project files. For example, a software company may have developers located at multiple geographically dispersed locations. The applications utilized by the developers at a remote location to develop a software project may connect to the network of the main location (e.g., the main office) across a Virtual Private Network (VPN) over a WAN. However, VPN connections over a WAN typically have low bandwidth, suffer from a high latency, and may be unreliable at times. As a result, the application operations preformed by developers at a remote location on project libraries and files over the VPN connections may be slow and may exhibit significant performance degradation. Even if the WAN has sufficient bandwidth, the WAN latency may still cause access to project libraries and files over the VPN connections to be slow. Further, if the network and file protocols utilized by the developers' applications at the remote location are “chatty” (e.g., if the protocols send a large number of small messages), then the developers at the remote location would typically experience even more delays and higher response times because the high WAN latency means that each of the small messages would take some time to deliver.

The disadvantages of the distributed development environment described above are not unique to distributed software development performed by a single software company. Rather, these disadvantages may be encountered in any type of collaborative software development that involves multiple participating entities at multiple development locations that are connected over slow communication links.

### BRIEF DESCRIPTION OF THE DRAWINGS

In the figures of the accompanying drawings like reference numerals refer to similar elements.

FIG. 1 is a flow diagram that illustrates an example method for transferring files to library cache areas according to one embodiment.

FIG. 2 is a flow diagram that illustrates an example method for transferring files to user-selected library cache areas according to one embodiment.

FIG. 3 is a block diagram that illustrates an example operational context for distributed software development according to embodiment.

FIG. 4 is a block diagram that illustrates an example computer system on which embodiments may be implemented.

### DETAILED DESCRIPTION

In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention. Various aspects of the invention are described hereinafter in the following sections:

I. OVERVIEW

II. TRANSFERRING PROJECT FILES TO LIBRARY CACHE AREAS

III. USER SELECTION OF LIBRARY CACHE AREAS

IV. CONFIGURING LIBRARY CACHE AREAS

V. USING REMOTE WORK AREAS

VI. EXAMPLE OPERATIONAL CONTEXT

VII. ADDITIONAL FEATURES AND ALTERNATIVE EMBODIMENTS

VIII. IMPLEMENTATION MECHANISMS

### I. Overview

Techniques are provided for using library caches in a distributed software development environment that includes a plurality of development sites. Each of the plurality of development sites is associated with at least one library cache area that is accessible over a LAN to a set of network nodes included in that development site.

In one embodiment, a configuration management server is operable to cause all of a plurality of files associated with a software project to be transferred, in an optimized package, from a file server to a particular development site that is communicatively connected to the file server over a WAN. The configuration management server is also operable to cause the plurality of files to be stored in a particular library cache area that is associated with the particular development site, and to cause one or more of the plurality of files to be transferred from the particular library cache area to a work area that is configured on a developer network node in the particular development site.

In one embodiment, a configuration management server is operable to receive a request from a developer network node in a particular development site of a plurality of development sites. A plurality of library cache areas is respectively associated with the plurality of development sites, where each library cache area associated with each development site is accessible over a LAN to a set of network nodes included in that development site. The request specifies a particular library cache area that is associated with the particular development site. Based on the request, the configuration management server is operable to select the particular library cache area from the plurality of library cache areas. The configuration management server is operable to cause a plurality of files associated with a software project to be transferred from a file server to a particular network node in the particular development site that manages the particular library cache area, where the particular network node is communicatively connected to the file server over a WAN. The configuration management server is also operable to cause the plurality of files to be stored in the particular library cache area associated with the particular development site, and to cause one or more of the plurality of files to be transferred from the particular library cache area to a work area that is configured on the developer network node.

### II. Transferring Project Files to Library Cache Areas

Techniques are described herein for using library caches in a distributed software development environment that includes a plurality of development sites. As used herein, “development site” refers to a set of network nodes that are communicatively connected over a LAN. “Network node” refers to a network-enabled computing device. A set of network nodes in a development site are operable to participate in distributed software development along with network nodes in other geographically dispersed development sites that are interconnected over one or more WANs.

According to the techniques described herein, a network node comprises one or more software components which, when executed by one or more processors, are operable to provide one or more software development functionalities including, without limitation, checking files and other project objects in, checking files and other project objects out, modifying files and other project objects, debugging source code files, compiling source code files, and testing executable files. A network node in a development site may also comprise one or more software components (e.g., a configuration management client or agent) which, when executed by one or more processors, are operable to request, receive, and/or store project files in a work area that is used by one or more developers for developing software.

As used herein, “developer work area” (or just “work area”) refers to a named storage location on a network node that is configured to store files and other project objects that can be used in applications utilized by a developer for developing software. A work area may be defined on any machine-readable medium and may be used for storing various objects related to the development life-cycle of a software project; examples of such objects include, but are not limited to, files, libraries, project objects (e.g., issues, change requests, defects, etc.), and various metadata information related thereto.

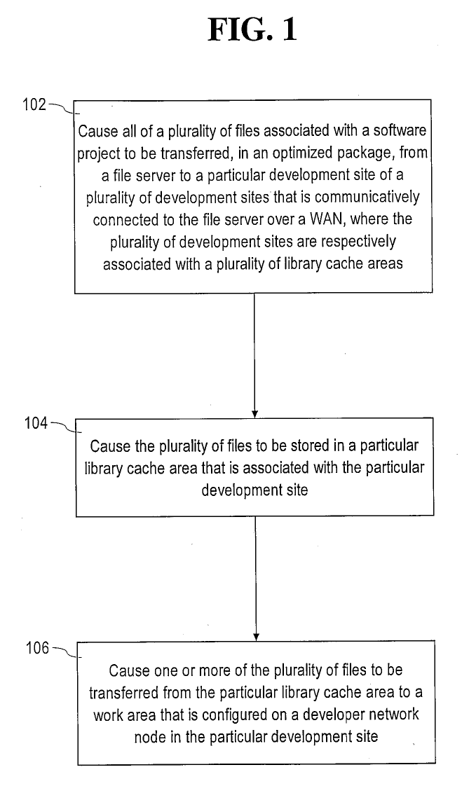

FIG. 1 is a flow diagram illustrating an example method for using library caches according to an embodiment that comprises a software configuration management server (also referred to herein as “configuration management server”) that is operable to perform the steps of the method.

A server is a combination of integrated software components and an allocation of computational resources (e.g., memory, CPU time, and/or disk storage space) on a network node for executing the software components. By utilizing its allocated resources, a configuration management server is operable to control and manage software project development by supporting various development functionalities including, without limitation, versioning of project files, configuring and managing software builds, and managing developer access to project files. For example, a configuration management server may be operable to provide components for authenticating and logging developers in and out, for maintaining developers' profiles, and for managing granular, per-developer access to projects and/or objects thereof.

In step 102, a configuration management server causes all files associated with a software project to be transferred, in an optimized package, from a file server to a particular development site that is communicatively connected to the file server over a WAN. “Optimized package” refers to an application-level unit of data that comprises one or more data packets, which collectively store a set of project files and which are configured for efficient transmission over the WAN. The particular development site is included in a plurality of development sites that are configured to participate in distributed software development that is configured in, and managed through, the configuration management server.

For example, in some operational scenarios the configuration management server may send to the file server a message that instructs the file server to send (or “push”) the files of a specified software project to the particular development site. (“Pushing” project files from the file server to the particular development site may provide at least for addressing communication issues caused by firewalls installed on the network path between the file server and the development site.) In response to the message, the file server or a component thereof generates an optimized package that comprises one or more data packets that store the project files. The data packets may be optimized and configured based at least in part on one or more network metrics of the WAN that connects the file server to the particular development site. For example, the file server or the component thereof may configure the sizes of the data packets in the optimized package by taking into account the latency and available bandwidth of the WAN so that the transfer time of the entire optimized package over the WAN would be minimized.

In another example, in some operational scenarios the configuration management server may send a message to a particular network node in the particular development site. The message includes information instructing the network node to retrieve (or “pull”) the files of a specified project from the file server to the particular development site. In response to the message, the network node or a component thereof retrieves (e.g., downloads) from the file server an optimized package that comprises one or more data packets that store the project files. The one or more data packets may be optimized and configured by the file server based at least in part on one or more network metrics of the WAN, for example the latency and available bandwidth of the WAN, so that the transfer time of the entire package over the WAN would be minimized.

In step 104, the configuration management server causes the project files sent from the file server to be stored in a library cache area associated with the particular development site.

As used herein, “library cache area” (or “LCA”) refers to a named storage location on a network node that is accessible by a set of network nodes in a development site. A library cache area may be defined on any machine-readable medium and may be used for storing various objects related to the development life-cycle of a software project; examples of such objects include, but are not limited to, files, libraries, project objects (e.g., issues, change requests, defects, etc.), and various metadata information related thereto. For any given development site, one or more library cache areas may be defined on one or more network nodes that are close or proximate (e.g., on the same LAN) to network nodes that are used by the developers at that development site for developing software.

According to the techniques described herein, “library cache area node” (or “LCA node”) refers to a network node in a development site that comprises one or more LCA components which, when executed, are operable to provide access to, create, update, and otherwise manage a library cache area. In addition, in some embodiments an LCA node may also be running one or more of a file server, a cache server, and any other software component operable to provide and control access to files.

In step 106, the configuration management server may cause one or more of the project files stored in the library cache area associated with the particular development site to be transferred from the library cache area to a work area that is configured on a developer network node in that development site. For example, in some embodiments the configuration management server may send a message to the LCA node that manages that library cache area. In these embodiments, the LCA node would send the one or more project files to the work area configured on the developer network node. In other embodiments, the configuration management server may send a message to the developer network node, where the message notifies the developer network node that the requested project files are stored in the library cache area managed by the LCA node. In response, in these embodiments the developer network node would download or otherwise retrieve the requested project files from the LCA node to the work area configured on developer network node.

In some embodiments the work area, to which project files are transferred from the library cache area, may be locally configured on the same network node that a developer is using to execute software development applications such as, for example, source code editors, compilers, linkers, and integrated development applications. In other embodiments, the developer work area may be configured on a network node that is remote to the network node that is used by the developer to execute software development applications.

In some embodiments, the steps of the example method illustrated in FIG. 1 may be preceded by additional step or steps in which a determination is made whether requested project files are already present in a local library cache area or whether the requested project files need to be retrieved from a remote file server.

For example, in one embodiment a configuration management server may receive a request for one or more files of a particular project from a particular developer network node in a particular development site. Based on the request, the configuration management server or a component thereof may automatically determine a particular library cache area that is configured for responding to requests for files received from the particular developer network node (e.g., the configuration management server may determine that library cache area which is associated with the development site to which the developer network node belongs). After identifying the particular library cache area, the configuration management server may determine whether that library cache area already stores copies of the project files requested by the developer network node (e.g., the configuration management server may inspect its configuration management data repository to determine whether the requested project files have recently been transferred to the library cache area). If the particular library cache area does not store the requested project files, then the configuration management server may perform the steps of the method illustrated in FIG. 1 to: cause the files of the project to be transferred from the remote file server to the particular development site; cause the transferred files to be stored in the particular library cache area; and cause the particular requested files to be transferred to the work area associated with the developer network node. If the particular library cache area already stores the requested project files (e.g., if the project files have been transferred to the particular library cache area within a configured time period) then, instead of retrieving the requested files from the remote file server, the configuration management server causes the particular requested files to be transferred from the particular library cache area to the work area associated with the developer network node.

In one embodiment, in response to a request from a developer node for a single file, the techniques described herein provide for transferring from a remote file server to a local library cache area all files and other objects that are associated with a given project. For example, suppose that a developer at a given development site logs in at the configuration management server and requests to check out a particular file of a particular project. If this is the first time during the day that a developer checks out a file from that particular project, the configuration management server would cause all files for that project to be transferred from the remote file server to the library cache area local to the given development site. Thereafter, any subsequent requests for any files of that particular project from any developer at the given development site would be responded to by retrieving the files from the local library cache area (as opposed to from the remote file server) and storing them into the developer's work area. In this manner, the techniques described herein provide for reducing the network traffic exchanged over the WAN between the development site and the remote file server that is designated as the primary storage location for the files of the particular project.

In one embodiment, the techniques described herein provide for transferring from a remote file server to a local library cache area only those project files that have been modified since the last transfer of the project files to the local library cache area. For example, in response to a request for a file from a developer node, a configuration management server would first determine all the files that are associated with same project as the requested file. Based on records indicating which versions of the project files have been transferred to the local library cache area, the configuration management server would determine the set of project files that have been modified since the last transfer of project files from the remote file server. Thereafter, the configuration management server would cause only the modified files (as opposed to all files of the project) to be transferred from the remote file server to the local library cache area. In this manner, the techniques described herein provide for reducing the network traffic exchanged over the WAN between the development site and the remote file server as well as performing conflict resolution over different versions of the project files.

In some embodiments, a configuration management server may comprise one or more software components or other logic which, when executed, are operable to download or otherwise cause the downloading of project files in an on-demand or periodic manner. For example, the configuration management server may comprise one or more components that are operable to receive requests for project files from developer nodes and, in response to the requests, to download or cause the download of project files from a remote file server to library cache areas associated with the development sites that include the developer nodes. In another example, the configuration management server may comprise one or more components that are operable to receive user input specifying a schedule for downloading or causing the download of project files, where the schedule may based on specified date/times and/or on specified time intervals. In this example, the configuration management server would be operable to download or cause the download of project files and other project objects from a remote file server to a local library cache area according to the user-specified schedule.

### III. User Selection of Library Cache Areas

In some embodiments, the techniques described herein for using library cache areas in distributed software development provide developers with the capability to select the library cache areas from which to retrieve project files. This capability is useful for developers who may travel from one development site to another.

For example, a development manager who is resident at development site “A” in the United Kingdom may travel to development site “B” in India. While at the development site in India, according to the techniques described herein the development manager would be able to change the library cache area associated with the work area on her laptop computer to a library cache area that is proximate to development site “B”. Then, when the development manager goes to development site “C” (in Germany, for example), the development manager would be able to update her library cache area again to a library cache area that is proximate to development site “C”.

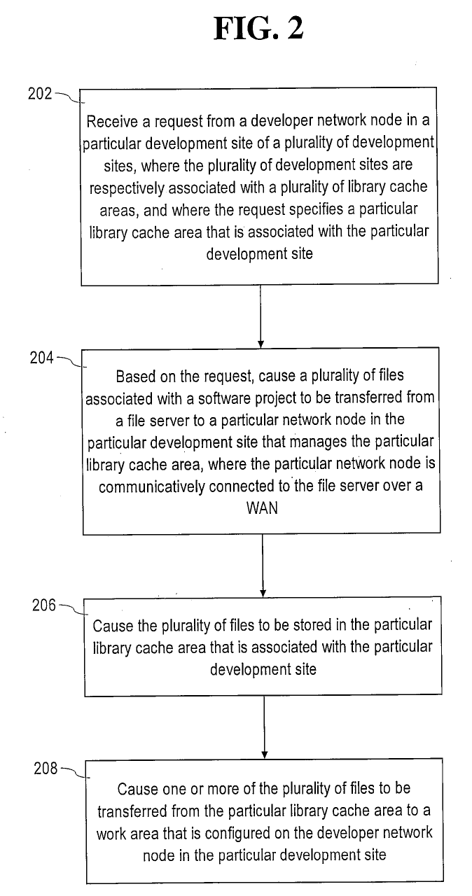

FIG. 2 is a flow diagram that illustrates an example method for transferring files to user-selected library cache areas. In one embodiment, a configuration management server is operable to perform the steps of the example method illustrated in FIG. 2.

In step 202, a configuration management server receives a request from a developer network node in a particular development site of a plurality development sites that are configured for participating in distributed software development. The request specifies a particular library cache area, of a plurality of library cache areas, from which a developer utilizing the developer network node wants to download project files.

In some embodiments, the request may directly identify the particular library cache area. For example, the request may include information that is received from the developer via a User Interface (UI) provided by the developer network node, where the information identifies the particular library cache area. The information identifying the particular library cache area may include, without limitation, a network address and/or port of the LCA node managing the particular library cache area, a network address or mask identifying the development site associated with the particular library cache area, and/or any other LCA identifier that may be assigned to the particular library cache area by the configuration management server and/or by another LCA authority.

In some embodiments, the request may indirectly identify the particular library cache area. For example, a developer may log in at the configuration management server. Based on the developer's identifier provided at log in, the configuration management server may find and inspect the developer's profile stored in a configuration management data repository, and may determine the particular library cache area from a default or another LCA attribute that is set by the developer in the profile.

In step 204, based on the received request the configuration management server causes one or more project files to be transferred to the particular library cache area. For example, in addition to specifying the particular library cache area, the received request may also specify the project and/or the project files that the developer wants to transfer to her work area.

In one embodiment, the configuration management server may store in a data repository metadata information about project files of one or more projects and a plurality of LCA identifiers that respectively identify a plurality of library cache areas. In this embodiment, when the configuration management server receives a request from a developer network node, the configuration management server may first determine the particular library cache area that is to be used for storing the project files by comparing an LCA identifier specified in the received request against the plurality of LCA identifiers stored in the data repository. After determining the particular library cache area, the configuration management server may determine whether the project files specified in the received request are stored in the particular library cache area by comparing file information in the received request (e.g., file names, version numbers of the project files, etc.) to metadata information about the project files that is stored in the data repository.

If the configuration management server determines that the project files (or current versions thereof) specified in the received request are already stored in the particular library cache area, then the configuration management server proceeds with step 208. If the requested project files have not yet been transferred to the particular library cache area, then in step 206 the configuration management sever causes the project files to be transferred from a remote file server (which provides the primary storage location for the project files) to the particular library cache area.

In some embodiments, in step 206 the configuration management server may send to the remote file server a message that instructs the remote file server to send the requested project files to the particular library cache area. In response to the message, the remote file server or a component thereof may generate an optimized package comprising one or more data packets that store the requested project files, and may send the optimized package to the LCA node that manages the particular library cache area.

In some embodiments, in step 206 the configuration management server may send a message to the LCA node that manages the particular library cache area. The message may include information instructing the LCA node to retrieve the requested project files from the remote file server. In response to the message, the LCA node or a component thereof may retrieve from the remote file server an optimized package comprising one or more data packets that store the requested project files.

In step 208, the configuration management server may cause one or more of the requested project files to be transferred from the particular library cache area to a work area that is configured for the developer network node that sent the request. For example, in some embodiments, the configuration management server may send a message to the LCA node that manages the particular library cache area. In these embodiments, the LCA node would send the one or more requested project files to the work area configured for the developer network node. In other embodiments, the configuration management server may send a message to the developer network node, where the message notifies the developer network node that the requested project files are stored in the particular library area. In response, in these embodiments the developer network node would download or otherwise retrieve the requested project files from the LCA node managing the particular library cache area to the work area configured for developer network node.

### IV. Configuring Library Cache Areas

### Setting Up and Managing Library Cache Areas

The techniques for using library cache areas described herein provide mechanisms for defining and accessing library cache areas. For example, according to the techniques described herein a configuration management server may store LCA definition information in a configuration management data repository. In addition, a configuration management server and/or a LCA node may provide one or more interfaces, libraries, or modules for accessing library cache areas and data stored therein.

In one embodiment, a library cache area may be associated with a definition, where the definition may include one or more LCA attributes that may include, but are not limited to, the following:
DESCRIPTION=<desc>—this attribute provides a description of the library cache area;
DIRECTORY=<dir>—this attribute specifies the directory in which the library cache area is located;
NETWORK_NODE=<net>—this attribute specifies the network address (e.g., IP address) of the LCA node where the library cache area is stored;
OWNER=<owner>—this attribute specifies the operating system account of the owner of the library cache area;
PASSWORD=<area_user_pwd>—this attribute stores the password of the owner account, where the value of this attribute may be stored in an encrypted form;
STATUS=<status>—this attribute specifies a status of the library cache area.

One embodiment may also provide commands for selecting, creating, updating, and listing available library cache areas. In this embodiment, the commands may be executed through a Graphical User Interface (GUI) and/or through a Command-Line Interface (CLI). Examples of some commands are provided below:
a command to select a library cache area for a project:
   SCWS <project> . . . /LIBRARY_CACHE_AREA=<area-id>
a command to create a library cache area and the corresponding definition:

```
CLCA <area>
  /DESCRIPTION=<desc>
  /DIRECTORY=<dir>
  /NETWORK_NODE=<net>
  /OWNER=<owner>
  /STATUS=<status>
  /PASSWORD=<area_user_pwd>
  /USER=<area_user>
```

a command to update a library cache area definition:

```
ULCA <area>
  /DESCRIPTION=<desc>
  /DIRECTORY=<dir>
  /NETWORK_NODE=<net>
  /OWNER=<owner>
  /STATUS=<status>
  /PASSWORD=<area_user_pwd>
  /USER=<area_user>
  /new_name=<NEWID>
```

a command to list available library cache area definitions:

LLCA <area>
/NETWORK_NODE=<net>

### Configuring Library Cache Areas for Projects

According to the techniques described herein, a library cache area may be associated with, and store the project objects of, one or more software development projects. After a developer logs in at a configuration management server, the developer typically would work in the context of one or more projects. Using the techniques described herein, an administrator of the configuration management server may set up and configure a plurality library cache areas in a respective plurality of development sites.

According to the techniques described herein, a configuration management server may provide data structures in a data repository that are configured for storing attributes and properties that are associated with projects and library cache areas. For example, each project managed by the configuration management server may be associated with one or more global properties or attributes (which may specify, for example, the project description, the branch module of the project, whether parallel checkout for the project is enabled, etc.) and one or more per-user properties or attributes (for example, an attribute that specifies, for each developer, the network path to the work area of that developer). In addition, the configuration management server may also provide data structures and mechanisms for allowing a developer to select a preferred library cache area and to specify various options, such as, for example, how and when the files and other objects of a particular project get to be cached.

In one embodiment a developer may set as default, or otherwise associate with, a particular project. In this embodiment, a per-user project property is provided at least in order to allow each developer to select a library cache area (from one or more library cache areas configured for this project) that the developer wants to use when the developer works on this project. It is noted that while a particular library cache area may be selected by a developer for a particular project, a library cache area is not limited to storing only files and objects from a single project. The techniques for using library cache areas described herein allow any library cache area to store the files and objects for one or more projects simultaneously; for example, the number of projects stored in a particular library cache area may reflect the number of projects worked on by developers at the development site associated with that library cache area.

In one embodiment, a developer may log in at a configuration management server by using a GUI provided on a network node utilized by the developer. Thereafter, the developer may select (from the appropriate control on the GUI) a particular project that the developer wants to work on. After selecting the particular project, the developer may select from properties associated with the project (e.g., through the appropriate controls on the GUI) a LCA per-user property associated with that project. The LCA property may be reflected in a list menu or a drop-down box that lists all library cache areas that are configured to provide the files and objects for the particular project. The developer may then select one or more of the listed library cache areas as the set of library cache areas from which the developer would like to receive the files and objects of that particular project. Typically, the developer would select the library cache area that is proximate to the developer's location, for example, the library cache area that is accessible over a LAN that is local to the network node utilized by the developer.

In this manner, a developer may configure a particular library cache area in association with a particular project. Thereafter, all transfers of files for that particular project to the developer's work area are going to be performed from the particular library cache area specified by the developer.

### Types of Data Stored in Library Cache Areas

The techniques for using library cache areas described herein are not limited to any particular type of project files and objects that can be stored in the library cache areas. Rather, the project objects that may be stored and managed in accordance with the techniques described herein may be files and other project objects that may be managed by a configuration management server in a collaborative distributed software development. For example, the configuration management server may be operable to control and manage the development of a software project by supporting versioning of files and other project objects. According to the techniques described herein, examples of project files and objects include, without limitation, source code files, object code files, executable files, and any type of metadata information associated therewith.

In an example embodiment, the project objects that may be stored in a library cache area include, without limitation, items objects, change request objects, and baseline objects. An item object may comprise a file and metadata information associated with that file. For example, a source item may comprise a file that stores source code and metadata information associated with that source code file. The metadata information associated with a file may include any user-defined attributes for the file including, but not limited to, a type of encoding used on the file, identifiers of one or more projects to which the file is attached, an identifier of the current owner of the file, the time at which the file was created, last accessed, and/or last updated, the version of the file, and a status reflecting the development life-cycle of the file. The status reflecting the development life cycle of the file may be data indicating whether the file is created, reviewed, approved, tested, etc.

A change request object (also referred to as a change document object) may comprise a file and metadata information associated with that file. Similarly to the metadata information included in an item object, an example of the metadata information included in a change request object may include, without limitation, information indicating the creator of the request, the time the request was created, last accessed, and/or last updated, a status reflecting the development life cycle of the request, the user-defined properties of the request, etc. In addition, the metadata information included in a change request object may also comprise developer-attached tags indicating descriptions of various issues associated with the corresponding file as the file moves through its development life-cycle. The metadata information included in a change request object may also comprise data indicating the relationships between that change request object and any other item and/or change request objects.

A baseline object may comprise a collection (or collector object) of one or more item objects and/or one or more change request objects. A baseline object may comprise metadata information that may indicate the logical structure of the one or more items and/or change request objects included in the baseline object and the relationships between any item and/or change request objects. In addition, similarly to the metadata information included in item and change request objects, examples of the metadata information associated with a baseline object may include, without limitation, information indicating the creator of the baseline object, the time the baseline object was created, last accessed, and/or last updated, a status reflecting the development life cycle of the baseline object, any of the user-defined properties of the baseline object, etc.

### V. Using Remote Work Areas

According to the techniques for using library cache areas described herein, a developer may specify the storage location of a work area locally at the developer's network node (e.g., as “C:\Project_A\”) or remotely on another network node in the same development site (e.g., as “\\FileServer_X\Project_A\” where “\\FileServer_X” is a server node accessible over the LAN in the development site).

In one embodiment, a developer may configure her work area in a development site on a network node that is different than the network node which the developer is utilizing to develop software. In this embodiment, a client on a developer's network node may request from a configuration management server to retrieve a particular project file to the developer's remote work area. When the configuration management server receives such request, according to the techniques described herein the configuration management server would not notify the client that the requested project file is located in the library cache area configured by the developer for this project. Rather, the configuration management server would automatically recognize that the target work area (where the requested project file is to be transferred) is remote with respect to the developer's network node. The configuration management server would then cause the requested project file to be transferred to the developer's remote work area. For example, the configuration management server may itself copy the requested file from the library cache area to the developer's remote work area. In another example, the configuration management server may send the appropriate request to the LCA node that manages the library cache area, and in response the LCA node may copy the requested project file to the developer's remote work area. In another example, the configuration management server may send a notification to a configuration management agent executing on the network node that manages the developer's work area, and in response the agent may transfer the file from the library cache area to the developer's remote work area.

### VI. Example Operational Context

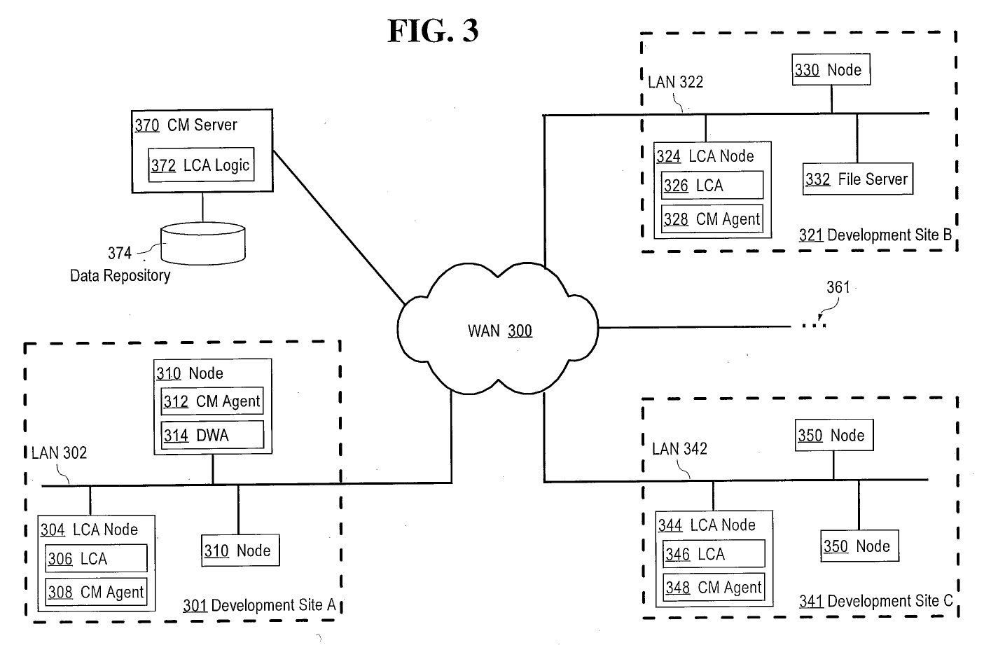

FIG. 3 is a block diagram that illustrates an example operational context for distributed software development according to one embodiment. The operational context illustrated in FIG. 3 comprises development sites 301, 321, and 341 that are communicatively connected over WAN 300 to each other and to configuration management server 370. The operational context illustrated in FIG. 3 may include any number of other development sites as illustrated by ellipses 361.

For illustration purposes, FIG. 3 depicts that development sites 301, 321, and 341 are communicatively connected over a WAN. However, the techniques for using library cache areas described herein may be implemented in distributed software development environments in which multiple development sites are communicatively connected over relatively slow communication links other than a WAN. Examples of such relatively slow communication links include, without limitation, dial-up connections, Digital Subscriber Line (DSL) connections, Integrated Services Digital Network (ISDN) connections, and Metropolitan Area Network (MAN) connections.

Development site 301 (depicted in FIG. 3 as development site “A”) comprises network nodes 310 and LCA node 304 that are communicatively connected over LAN 302. LAN 302 is communicatively connected to WAN 300 by means of one or more network infrastructure elements such as routers or switches.

Each of the network nodes 310 in development site 301 comprises a configuration management agent 312. In addition, a network node 310 may also comprise a developer work area (DWA) 314.

Configuration management agent 312 is a software component which, when executed by one or more processors, is operable to provide at a network node 310 various client-side functionalities for configuration management server 370. Examples of such client-side functionalities include, but are not limited to, logging at configuration management server 370 a developer that utilizes a network node 310, providing connectivity to configuration management server 370 for any software development applications that execute at a network node 310, and processing any information and requests that are sent to and received from configuration management server 370. In addition, according to the techniques described herein, configuration management agent 312 may also be operable to retrieve files and other project objects from LCA node 304 and store them in developer work area 314.

Developer work area (DWA) 314 is a named storage location on a network node 310 that may be configured to store files and other project objects that can be used by developers utilizing one or more network nodes in development site 301. Developer work area 314 may be configured on any machine-readable medium managed by network node 310 that is accessible to one or more software development applications utilized by developers on a local and/or remote network nodes 310.

LCA node 304 comprises library cache area 306 and configuration management agent 308. Library cache area 306 is a named storage location on LCA node 304. Library cache area 306 may be configured on any machine-readable medium managed by LCA node 304 that is accessible by other network nodes in development site 301.

Configuration management agent 308 is operable to perform substantially the same client-side functionalities described herein for configuration management agent 312. In addition, configuration management agent 308 is operable to perform the functionalities described herein for using library cache areas at development sites. For example, in the operational context illustrated in FIG. 3, configuration management agent 308 may comprise one or more LCA components which, when executed, are operable to provide access to, create, update, and otherwise manage library cache area 306. Configuration management agent 308 may also include components that are operable to perform various cache-management functionalities according to any now known or later developed cache mechanisms. Examples of cache-management functionalities include, without limitation, retrieving files and other project objects from remote file servers, storing files and other project objects into a library cache area, and periodically synchronizing with a remote file server the files and project objects stored in a library cache area. It is noted that in various embodiments, the cache-management functionalities for managing the information stored in a library cache area may be performed by components of an LCA node other than the configuration management agent such as, for example, one or more of a file server, a cache server, or any other software component operable to provide and control access to files.

Similarly to development site 301, development site 321 (depicted in FIG. 3 as development site “B”) comprises one or more network nodes 330 and an LCA node 324 that are communicatively connected over LAN 322. LAN 322 is communicatively connected to WAN 300 by means of one or more network infrastructure elements such as routers or switches. Each of the network nodes 330 in development site 321 comprises a configuration management agent such as configuration management agent 312 described herein with respect to network node 310. In addition, a network node 330 in development site 321 may also comprise one or more developer work areas such as developer work area 314 described herein with respect to network node 310. LCA node 324 comprises library cache area 326 and configuration management agent 328, which are substantially similar in structure and functionalities respectively to library cache area 306 and configuration management agent 308 that are described herein with respect to LCA node 304.

Development site 321 also comprises a file server node 332. The file server at node 332 is operable to manage access to the files and other project objects of projects that are collaboratively developed at development sites 301, 321, and 341 under the management of configuration management server 370. For example, the file server at node 332 may be designated as the primary storage location for the files and other objects of one or more particular projects. In some operational contexts, all projects collaboratively developed at multiple development sites may be stored at the same file server (such as, for example, the file server at node 332) in one particular development site. In other operational contexts, more than one of multiple development sites may provide a file server that is configured as the primary storage location for different projects. In some operational contexts a file server, which is operable to manage access to the files and other project objects, may be configured on the same network node that is operable to execute a configuration management server that manages the collaborative software development at multiple development sites. Thus, the depiction of the file server at node 332 in development site 321 is provided herein for illustration purposes only and is not to be regarded in a restrictive or limiting sense.

Similarly to development site 301, development site 341 (depicted in FIG. 3 as development site “C”) also comprises one or more network nodes 350 and an LCA node 344 that are communicatively connected over LAN 342. LAN 342 is communicatively connected to WAN 300 by means of one or more network infrastructure elements such as routers or switches. Each of the network nodes 350 in development site 341 comprises a configuration management agent such as configuration management agent 312 described herein with respect to network node 310. In addition, a network node 350 in development site 341 may also comprise one or more developer work areas such as developer work area 314 described herein with respect to network node 310. LCA node 344 comprises library cache area 346 and configuration management agent 348, which are substantially similar in structure and functionalities respectively to library cache area 306 and configuration management agent 308 that are described herein with respect to LCA node 304.

Configuration management server 370 is communicatively connected over WAN 300 to development sites 301, 321, 341, and to any other development sites (as indicated by ellipses 361) that may be participating in the collaborative, commonly-managed distributed software development. While configuration management server 370 is not depicted as part of any development site, it is noted that the network node executing configuration management server 370 may be included in any development site for which the configuration management server is used for managing software development. For example, the network node executing configuration management server 370 may be configured on any one of LANs 302, 322, and 342 in development sites 301, 322, and 342, respectively. Thus, the depiction of configuration management server 370 in FIG. 3 is merely illustrative and is not to be regarded in a restrictive or limiting sense.

Configuration management server 370 is operable to control and manage software project development by supporting various development functionalities including, without limitation, versioning of project files, configuring and managing software builds, managing developer access to project files, authenticating and logging developers in and out, maintaining developers' profiles, and managing developer access to projects and/or objects thereof.

In addition, to support the various functionalities of the techniques for using library cache areas described herein, configuration management server 370 comprises LCA logic 372. LCA logic 372 is a software component which, when executed, is operable to perform the various functionalities of the techniques described herein including, without limitation: receiving requests for files from developer nodes; determining/selecting library cache areas on behalf of developer network nodes; causing project files and other project objects to be transferred from remote file servers to local library cache areas; causing project files and other project objects to be transferred from library cache areas to developers' work areas; and performing with respect to library cache areas various cache-management functionalities according to any now known or later developed cache mechanisms. It is noted that in various embodiments, the cache-management functionalities for managing the information stored in library cache areas may be performed by network node components other than LCA logic 372. For example, the cache-management functionalities may be performed by software components executing on a network node in conjunction with a configuration management server such as, for example, one or more of a file server, a cache server, or any other software component operable to provide and control access to files.

To support its software project management and library cache management functionalities, configuration management server 370 is communicatively and/or operatively connected to data repository 374. Data repository 374 may be any type of structured storage for storing data including, but not limited to, a relational or object-oriented database, a directory, a set of data files, and any other structured data storage. In the operational example of FIG. 3, data repository 374 may be a configuration management database that stores records with various software project management and library cache management information. Examples of software project management information include, without limitation, developer identifiers, project identifiers, per-project file and object associations, versions of files and other project objects, listings of project files and other objects that are checked in and out, and various development life-cycle statuses of projects, project files, and other project objects. Examples of library cache management information include, without limitation, library cache area identifiers, file server identifiers of file servers that store files and other project objects, per-developer selections or defaults of library cache areas, identifiers of transferred project files and objects in association with identifiers of the library cache areas where the project files and objects were transferred to, the date/times at which transfers took place, and the versions of the files and other project objects that were transferred and stored into library cache areas.

In one operational example, suppose that a developer utilizing network node 310 in development site 301 logs in at configuration management server 370. After logging in, the developer requests one or more files of a particular project through configuration management agent 312 that executes on network node 310. In response to the request, configuration management server 370 and/or one or more components thereof may perform the following functional steps:
Based on the user ID of the developer, configuration management server 370 may first check whether the developer has the necessary privileges and permissions to access the requested project files.
If configuration management server 370 determines that the developer has the necessary privileges and permissions to access the requested project files, then LCA logic 372 in configuration management server 370 may determine the particular library cache area that the developer has previously selected and configured for the particular project that includes the requested project files. For example, LCA logic 372 may locate a record in data repository 374 based on the user ID of the developer and the project ID of the particular project, and may retrieve from the located record the library cache area ID of library cache area 306.
After determining that library cache area 306 is configured for responding to the received request, LCA logic 372 may determine whether each requested project file has already been transferred to that library cache area. For example, LCA logic 372 may perform this step by locating and comparing records in data repository 374 that store the identifiers of the requested project files and the identifiers of the files stored in library cache area 306. In addition, LCA logic 372 may perform other operations based on other information that may be stored in the located records, such as, for example, version-based and/or time-of-transfer-based comparisons.
If LCA logic 372 determines that the requested project files (or the latest versions thereof) have not already been transferred to library cache area 306, then LCA logic 372 transfers (or causes the transfer of) the requested project files to that library cache area. For example, based on the project ID of the particular project, LCA logic 372 may first determine from data repository 374 the primary storage location of the files and objects of that project. Suppose that LCA logic 372 identifies the file server at node 332 in development site 321 as the primary storage location of the files and objects of the particular project. LCA logic 372 may then send a message to the file server at node 330, where the message instructs the file server to package into an optimized package all the files and other objects of the particular project and to send the optimized package to LCA node 304. Alternatively, LCA logic 372 may send a message to configuration management agent 308 in LCA node 304, where the message instructs the configuration management agent to retrieve the requested project files (or all files of the particular project) from the file server on node 332 at development site 321.
After the transfer is completed, configuration management server 370 and/or LCA logic 372 may update data repository 374 accordingly. For example, one or more records may be added to data repository 374 to indicate that the requested project files (or all files of the particular project) have been transferred to library cache area 306.
Configuration management server 370 or LCA logic 372 may then send a message to configuration management agent 312 on developer network node 310, where the message notifies the configuration management agent that the requested project files are stored in, can be retrieved from, library cache area 306.
In response to receiving the message, configuration management agent 312 retrieves the requested project files from library cache area 306 and stores the retrieved files in developer work area (DWA) 314. For example, configuration management agent 312 may copy the requested project files from library cache area 306. In another example, configuration management agent 312 may send a request for the project files to a cache server that manages library cache area 306, and in response the cache server may send the files to node 310. In another example, configuration management agent 312 may use an FTP transfer to retrieve the requested project files from library cache area 306. The techniques described herein are not limited to any particular means or mechanisms by which a client or agent on a developer network node may retrieve files from a library cache area, and any means and mechanisms that provide fast file retrieval over a LAN may be used.

In the above manner, a configuration management server may populate library cache areas with project files on demand. The configuration management server may transfer (or cause the transfer of) all files and/or objects of a project to a library cache area in response to the first request for a file or an object of that project; any subsequent requests (either from the same or different developer network nodes) to retrieve any file or object of that project would result in retrieving that file or object from the library cache area.

It is noted that the operational context illustrated in FIG. 3 may include other implementation-dependant components and elements that are not depicted in FIG. 3 in order to avoid unnecessarily obscuring the techniques described herein for using library cache areas in distributed software development. Thus, the operational context illustrated in FIG. 3 and the specific details thereof are to be regarded in an illustrative rather than a restrictive sense.

### VII. Additional Features and Alternative Embodiments

In one embodiment, a configuration management server may automatically determine a library cache area for a developer at the time the developer logs in at the server. For example, based on log-in information associated with the developer (e.g. IP address, domain from which the log-in was initiated, session identifier, etc.), the configuration management server may automatically determine which library cache area is suitable for the developer to use. A suitable library cache area may be a library cache area that is proximate to the developer (e.g., on the same LAN as the developer, on the same subnet as the developer, in the same network domain as the developer, etc.), or a library cache area that satisfies one or more predetermined criteria for facilitating automatic selection. In this embodiment, when a developer (who is resident at development site “A”) travels to development site “B”, the configuration management server would automatically determine that the developer is logging in from development site “B” and would automatically change the developer's library cache area accordingly. In this embodiment, the configuration management server may make the automatic determination of a library cache area on a project-by-project basis, for example, for each project as that project is accessed by the developer from the new development site.

In some embodiments, the techniques for using library cache areas described herein provide for transferring to and storing in library cache areas files and objects of projects that are currently being collaboratively developed at multiple development sites. Ii some embodiments, the techniques described herein may provide for transferring to and storing in library cache areas test versions of software projects or applications. In addition, or instead of, in some embodiments the techniques described herein provide for transferring to and storing in library cache areas previous versions software projects and applications. Thus, the techniques described herein are not limited to storing files and object of any particular types or versions of software projects and applications, and for this reason the examples of projects and applications provided throughout the present disclosure are to be regarded in an illustrative rather than a restrictive sense.

### VIII. Implementation Mechanisms

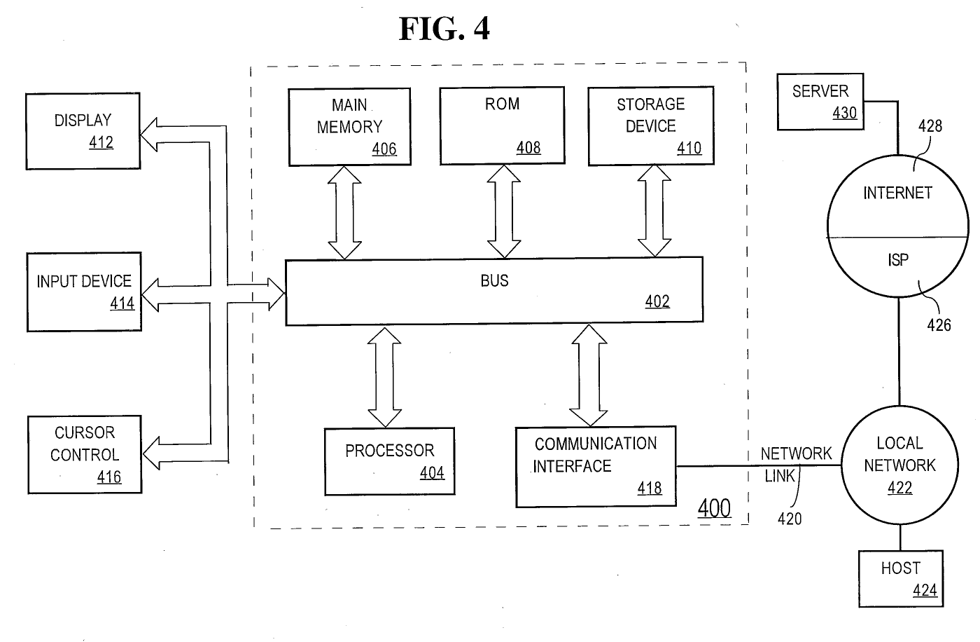

FIG. 4 is a block diagram that illustrates an example computer system 400 upon which embodiments of the techniques described herein may be implemented. For example, computer system 400 may be used to implement a configuration management server operable to perform the techniques described herein. In another example, computer system 400 may be used to implement an LCA node that manages a library cache area according to the techniques described herein. In other examples, computer system 400 may be used to implement a developer network node and/or a file server operable to store software project files. It is noted that the servers and nodes that are operable to perform the techniques described herein may be implemented in any context and on any kind of computing platform or architecture, and are not limited to any particular context, computing platform, or architecture; thus, computer system 400 is to be regarded in an illustrative rather than a restrictive sense.

Computer system 400 includes a bus 402 or other communication mechanism for communicating information, and a processor 404 coupled with bus 402 for processing information. Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402, a graphics display component (not shown), and a display driver (not shown) to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

The invention is related to the use of computer system 400 for implementing the techniques described herein for using library cache areas in distributed software development. According to one embodiment, these techniques are performed by computer system 400 in response to processor 404 executing one or more sequences of one or more instructions contained in main memory 406. Such instructions may be read into main memory 406 from another machine-readable medium, such as storage device 410. Execution of the sequences of instructions contained in main memory 406 causes processor 404 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operate in a specific fashion. In an embodiment implemented using computer system 400, various machine-readable media are involved, for example, in providing instructions to processor 404 for execution. Such a medium may take many forms, including but not limited to, non-volatile media, volatile media, and transmission media. Non-volatile media includes, for example, optical or magnetic disks, such as storage device 410. Volatile media includes dynamic memory, such as main memory 406. Transmission media includes coaxial cables, copper wire and fiber optics, including the wires that comprise bus 402. Transmission media can also take the form of acoustic or light waves, such as those generated during radio-wave and infra-red data communications.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 404 for execution. For example, the instructions may initially be carried on a magnetic disk of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the worldwide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are exemplary forms of carrier waves transporting the information.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418. The received code may be executed by processor 404 as it is received, and/or stored in storage device 410, or other non-volatile storage for later execution. In this manner, computer system 400 may obtain application code in the form of a carrier wave.

In the foregoing specification, embodiments of the invention have been described with reference to numerous specific details that may vary from implementation to implementation. Thus, the sole and exclusive indicator of what is, and is intended by the applicants to be, the invention is the set of claims that issue from this application, in the specific form in which such claims issue, including any subsequent correction. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A computer-implemented method comprising:
causing all of a plurality of files associated with a software project to be transferred, in an optimized package, from a file server to a particular development site of a plurality of development sites, wherein the particular development site is communicatively connected to the file server over a Wide Area Network (WAN);
wherein the plurality of development sites are configured to participate in distributed software development;
wherein each development site, of the plurality of development sites, is associated with at least one library cache area that is accessible over a Local Area Network (LAN) to a set of network nodes included in that development site;
causing the plurality of files to be stored in a particular library cache area that is associated with the particular development site; and
causing one or more of the plurality of files to be transferred from the particular library cache area to a work area that is configured on a developer network node in the particular development site.

2. The computer-implemented method as recited in claim 1, further comprising:
receiving a request for at least one file of the plurality of files from the developer network node in the particular development site; and
based on the request, determining that the particular library cache area is configured to respond to requests for files from the developer network node;
wherein causing all of the plurality of files associated with the software project to be transferred comprises sending a message to the file server, wherein the message instructs the file server to generate the optimized package and to send the optimized package over the WAN to the particular development site.

3. The computer-implemented method as recited in claim 1, further comprising:
receiving a request for at least one file of the plurality of files from the developer network node in the particular development site; and
based on the request, determining that the particular library cache area is configured to respond to requests for files from the developer network node;
wherein causing all of the plurality of files associated with the software project to be transferred comprises sending a message to a particular network node in the particular development site that is operable to manage access to the particular library cache area, wherein the message instructs the particular network node to download all of the plurality of files from the file server over the WAN.

4. The computer-implemented method as recited in claim 1, wherein the optimized package comprises one or more data packets that store all of the plurality of files that are associated with the software project, wherein the sizes of the one or more data packets are configured at least in part based on one or more network metrics of the WAN.

5. The computer-implemented method as recited in claim 1, wherein the software project is any one of:
a current version of a software application that is being developed collaboratively at the plurality of development sites; and
a previous version of the software application.

6. The computer-implemented method as recited in claim 1, further comprising:
receiving a request for at least one file of the plurality of files from the developer network node in the particular development site;
based on the request,
determining that the particular library cache area is configured to respond to requests for files from the developer network node, and
determining whether the particular library cache area stores the plurality of files;
if the particular library cache area does not store the plurality of files, then causing all of the plurality of files to be transferred from the file server to the particular development site; and
if the particular library cache area stores the plurality of files, then causing the at least one file of the plurality of files to be transferred from the particular library cache area to the work area that is configured on the developer network node in the particular development site.

7. The computer-implemented method as recited in claim 1, wherein the method is performed by a configuration management server.

8. A computer-implemented method comprising:
receiving a request from a developer network node in a particular development site of a plurality of development sites;
wherein the plurality of development sites are configured to participate in distributed software development;
wherein a plurality of library cache areas is respectively associated with the plurality of development sites, wherein each library cache area associated with each development site is accessible over a Local Area Network (LAN) to a set of network nodes included in that development site;
wherein the request specifies a particular library cache area from the plurality of library cache areas, wherein the particular library cache area is associated with the particular development site;
based on the request, causing a plurality of files associated with a software project to be transferred from a file server to a particular network node in the particular development site that manages the particular library cache area, wherein the particular network node is communicatively connected to the file server over a Wide Area Network (WAN);
causing the plurality of files to be stored in the particular library cache area that is associated with the particular development site; and
causing one or more of the plurality of files to be transferred from the particular library cache area to a work area that is configured on the developer network node in the particular development site.

9. The computer-implemented method as recited in claim 8, wherein causing the plurality of files to be transferred from the file server to the particular network node in the particular development site further comprises causing the file server to generate an optimized package that comprises one or more data packets that store all files that are associated with the software project, wherein the sizes of the one or more data packets are configured at least in part based on one or more network metrics of the WAN.

10. The computer-implemented method as recited in claim 9, wherein causing the plurality of files to be transferred from the file server to the particular network node in the particular development site further comprises sending a message to the file server, wherein the message instructs the file server to generate the optimized package and to send the optimized package over the WAN to the particular network node.

11. The computer-implemented method as recited in claim 9, wherein causing the plurality of files to be transferred from the file server to the particular network node in the particular development site further comprises sending a message to the particular network node, wherein the message instructs the particular network node to download the optimized package from the file server over the WAN.

12. The computer-implemented method as recited in claim 8, wherein the method is performed by a configuration management server, and wherein the method further comprises:
the configuration management server storing, in a data repository, metadata information about the plurality of files associated with the software project and a plurality of identifiers that respectively identify the plurality of library cache areas;
the configuration management server determining the particular library cache area based on information included in the request and the plurality of identifiers stored in the data repository; and
the configuration management server determining the plurality of files for transferring to the particular library cache area based on the information included in the request and the metadata information stored in the data repository.

13. A machine-readable medium comprising one or more stored instructions which, when executed by one or more processors, are operable to:
cause all of a plurality of files associated with a software project to be transferred, in an optimized package, from a file server to a particular development site of a plurality of development sites, wherein the particular development site is communicatively connected to the file server over a Wide Area Network (WAN);
wherein the plurality of development sites are configured to participate in distributed software development;
wherein each development site, of the plurality of development sites, is associated with at least one library cache area that is accessible over a Local Area Network (LAN) to a set of network nodes included in that development site;
cause the plurality of files to be stored in a particular library cache area that is associated with the particular development site; and
cause one or more of the plurality of files to be transferred from the particular library cache area to a work area that is configured on a developer network node in the particular development site.

14. The machine-readable medium as recited in claim 13, wherein the one or more stored instructions further comprise instructions which, when executed by the one or more processors, are operable to:
receive a request for at least one file of the plurality of files from the developer network node in the particular development site; and
based on the request, determine that the particular library cache area is configured to respond to requests for files from the developer network node;
wherein the instructions operable to cause all of the plurality of files associated with the software project to be transferred comprise instructions which, when executed by the one or more processors, are operable to send a message to the file server, wherein the message instructs the file server to generate the optimized package and to send the optimized package over the WAN to the particular development site.

15. The machine-readable medium as recited in claim 13, wherein the one or more stored instructions further comprise instructions which, when executed by the one or more processors, are operable to:
receive a request for at least one file of the plurality of files from the developer network node in the particular development site; and
based on the request, determine that the particular library cache area is configured to respond to requests for files from the developer network node;
wherein the instructions operable to cause all of the plurality of files associated with the software project to be transferred comprise instructions which, when executed by the one or more processors, are operable to send a message to a particular network node in the particular development site that is operable to manage access to the particular library cache area, wherein the message instructs the particular network node to download all of the plurality of files from the file server over the WAN.

16. The machine-readable medium as recited in claim 13, wherein the optimized package comprises one or more data packets that store all of the plurality of files that are associated with the software project, wherein the sizes of the one or more data packets are configured at least in part based on one or more network metrics of the WAN.

17. The machine-readable medium as recited in claim 13, wherein the software project is any one of:
a current version of a software application that is being developed collaboratively at the plurality of development sites; and
a previous version of the software application.

18. The machine-readable medium as recited in claim 13, wherein the one or more stored instructions further comprise instructions which, when executed by the one or more processors, are operable to:
receive a request for at least one file of the plurality of files from the developer network node in the particular development site;
based on the request,
determine that the particular library cache area is configured to respond to requests for files from the developer network node, and
determine whether the particular library cache area stores the plurality of files;
cause all of the plurality of files to be transferred from the file server to the particular development site when the particular library cache area does not store the plurality of files; and
cause the at least one file of the plurality of files to be transferred from the particular library cache area to the work area that is configured on the developer network node in the particular development site when the particular library cache area stores the plurality of files.

19. The machine-readable medium as recited in claim 13, wherein the one or more stored instructions are included in the executable instructions of a configuration management server.

20. A machine-readable medium comprising one or more stored instructions which, when executed by one or more processors, are operable to:
receive a request from a developer network node in a particular development site of a plurality of development sites;
wherein the plurality of development sites are configured to participate in distributed software development;
wherein a plurality of library cache areas is respectively associated with the plurality of development sites, wherein each library cache area associated with each development site is accessible over a Local Area Network (LAN) to a set of network nodes included in that development site;
wherein the request specifies a particular library cache area from the plurality of library cache areas, wherein the particular library cache area is associated with the particular development site;
based on the request, cause a plurality of files associated with a software project to be transferred from a file server to a particular network node in the particular development site that manages the particular library cache area, wherein the particular network node is communicatively connected to the file server over a Wide Area Network (WAN);
cause the plurality of files to be stored in the particular library cache area that is associated with the particular development site; and
cause one or more of the plurality of files to be transferred from the particular library cache area to a work area that is configured on the developer network node in the particular development site.

21. The machine-readable medium as recited in claim 20, wherein the instructions operable to cause the plurality of files to be transferred from the file server to the particular network node in the particular development site further comprise instructions which, when executed by the one or more processors, are operable to cause the file server to generate an optimized package that comprises one or more data packets that store all files that are associated with the software project, wherein the sizes of the one or more data packets are configured at least in part based on one or more network metrics of the WAN.

22. The machine-readable medium as recited in claim 21, wherein the instructions operable to cause the plurality of files to be transferred from the file server to the particular network node in the particular development site further comprise instructions which, when executed by the one or more processors, are operable to send a message to the file server, wherein the message instructs the file server to generate the optimized package and to send the optimized package over the WAN to the particular network node.

23. The machine-readable medium as recited in claim 21, wherein the instructions operable to cause the plurality of files to be transferred from the file server to the particular network node in the particular development site further comprise instructions which, when executed by the one or more processors, are operable to send a message to the particular network node, wherein the message instructs the particular network node to download the optimized package from the file server over the WAN.

24. The machine-readable medium as recited in claim 20, wherein the one or more stored instructions are included in the executable instructions of a configuration management server, and wherein the one or more stored instructions further comprise instructions which, when executed by the one or more processors, are operable to:
store, in a data repository, metadata information about the plurality of files associated with the software project and a plurality of identifiers that respectively identify the plurality of library cache areas;
determine the particular library cache area based on information included in the request and the plurality of identifiers stored in the data repository; and
determine the plurality of files for transferring to the particular library cache area based on the information included in the request and the metadata information stored in the data repository.

25. A system comprising:
a plurality of development sites that are configured to participate in distributed software development;
a plurality of library cache areas that is respectively associated with the plurality of development sites, wherein each library cache area associated with each development site is accessible over a Local Area Network (LAN) to a set of network nodes included in that development site;
a file server that is communicatively connected over a Wide Area Network (WAN) to a particular development site of the plurality of development sites;
a configuration management server that is operable to cause the file server to transfer, in an optimized package, all of a plurality of files associated with a software project to a particular network node in the particular development site;
wherein the particular network node, in the particular development site, is operable to:
manage a particular library cache are from the plurality of library cache areas, wherein the particular library cache area is associated with the particular development site;
receive, from the file server, the optimized package with all of the plurality of files associated with the software project;
extract all of the plurality of files from the optimized package;
store all of the plurality of files in the particular library cache area, and
transfer one or more of the plurality of files from the particular library cache area to a work area that is configured on a developer network node in the particular development site.

26. The system as recited in claim 25, wherein the configuration management server is further operable to:
store, in a data repository, metadata information about the plurality of files associated with the software project and a plurality of identifiers that respectively identify the plurality of library cache areas;
receive a request for at least one file of the plurality of files from the developer network node in the particular development site;
determine the particular library cache area, from the plurality of library cache areas, based on information included in the request and the plurality of identifiers stored in the data repository; and
determine the plurality of files for transferring from the file server to the particular network node based on the information included in the request and the metadata information stored in the data repository.
